(19) United States
(12) Patent Application Publication
(10) Pub. No.: US 2011/0299236 A1
(43) Pub. Date: Dec. 8, 2011

(54) FIXING APPARATUS FOR HARD DISK DRIVE

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 12/837,484

(22) Filed: Jul. 15, 2010

(30) Foreign Application Priority Data
Jun. 3, 2010 (CN) 201010191099.X

(51) Int. Cl. G06F 1/16

(52) U.S. Cl. 361/679.36; 361/679.34

(57) ABSTRACT

A fixing apparatus includes a fixing member and a shockproof casing. The fixing member includes a first side plate, a second side plate, and a gate. Each of the first side plate and the second side plate defines a rail on corresponding inner sides for receiving a hard disk drive. Each of the first side plate and the second side plate includes a block plate fixed on a rear end thereof. One end of the gate is hinged on a front end of the first side plate, the other end of the gate latches on a front end of the second side pate. The shockproof casing includes a plurality of lock pins defined in each of two opposite inner sidewalls. The shockproof casing, of resilient material, seats the hard disk drive.

### BACKGROUND

1. Technical Field

The present disclosure relates to device mounting apparatuses and, particularly, to a fixing apparatus for hard disk drives (HDDs).

2. Description of Related Art

In a computer, a hard disk drive (HDD) is commonly used for storing information. Installing a mounting apparatus often used for mounting the HDD utilizing screws can be tedious and time-consuming. As manufacturers focus on improving mounting apparatuses, avoiding HDD damage from external shock may be overlooked.

Therefore, what is called for is a fixing apparatus for a hard disk drive addressing the limitations described.

### BRIEF DESCRIPTION OF THE DRAWINGS

Many aspects of the present device can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an exploded view of a fixing apparatus for a hard disk drive according to an exemplary embodiment.

FIG. 2 is an isometric view of the fixing apparatus of FIG. 1 showing the hard disk drive in position to be mounted in the fixing apparatus.

FIG. 3 is an assembled, isometric view of the fixing apparatus of FIG. 1.

### DETAILED DESCRIPTION

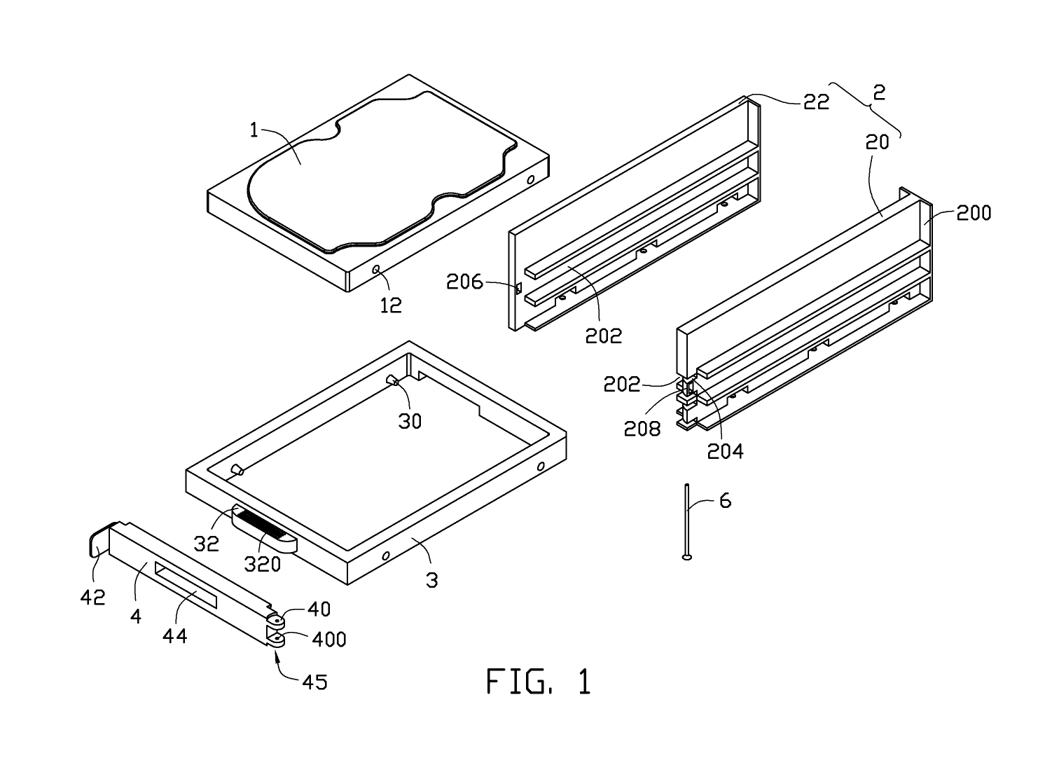

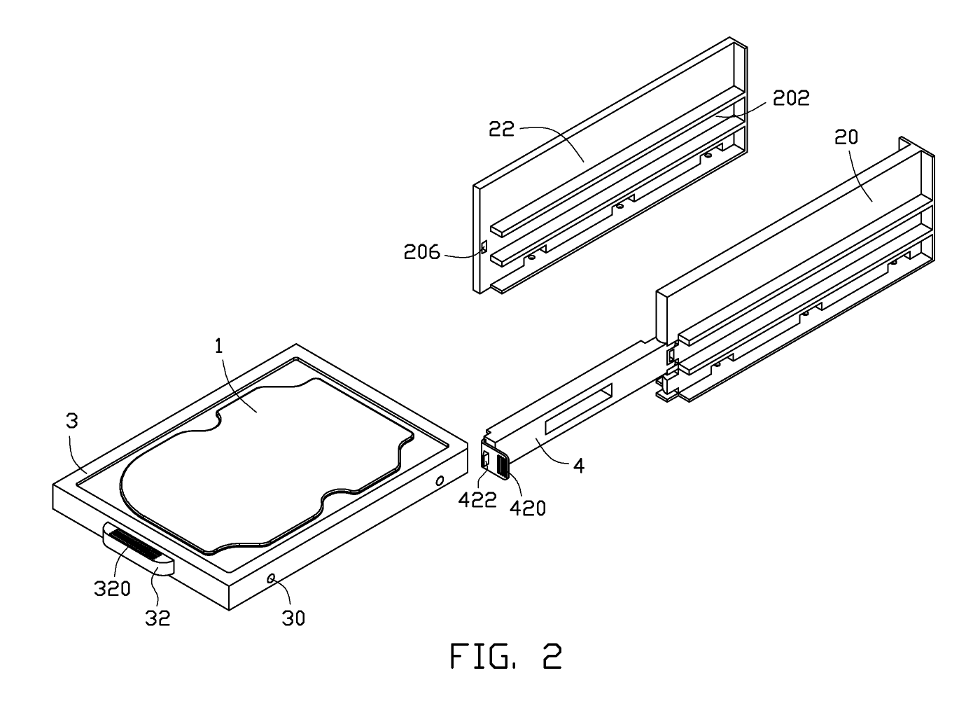

Referring to FIGS. 1 and 2, a fixing apparatus, according to an exemplary embodiment, is shown. The fixing apparatus for a hard disk drive (HDD) 1 includes a fixing member 2 and a shockproof casing 3. The HDD 1 includes a plurality of holes defined in each of two opposite sidewalls thereof. In the illustrated embodiment, the plurality of holes is shown as a pair of holes 12.

The fixing member 2 includes a first side plate 20, a second side plate 22 parallel to the first side plate 20, and a gate 4. Each of the first side plate 20 and the second side plate 22 defines a rail 202 in a corresponding inner side for receiving the shockproof casing 3, and includes a block plate 200 fixed on a rear end thereof to block the shockproof casing 3 with the HDD 1 retained therein. Two recesses 204 are defined in a front end of the first side plate 20. The two recesses 204 are separated by a distance and positioned adjacent the rail 202 of the side plate 20. A fixing portion 208 is defined between the two recesses 204. The fixing portion 208 defines a first through hole (not shown). A locking slot 206 is defined in a front end of the second side plate 22 and positioned adjacent to the rail 202.

One end of the gate 4 defines a heel 45. The heel 45 is hinged on the front end of the first side plate 20. The other end of the gate 4 includes a latching plate 42 extending therefrom. Two raised portions 40 are fixed on the heel 45. The two raised portions 40 are separated by a distance. Each of the two raised portions 40 defines a second through hole 400. A raised block 422 is fixed on an outer side of the latching plate 42. An anti-skid bumper 420 is fixed on a distal end of the latching plate 42. A cutout 44 is defined in the center of the gate 4.

A shockproof casing 3 of resilient material seats the HDD 1. The shockproof casing 3 includes a plurality of lock pins defined in each of two opposite inner sidewalls thereof. In the illustrated embodiment, a pair of lock pins 30 are utilized to engage with the holes 12 of the HDD 1. A handle 32 is fixed on a front end of the shockproof casing 3. An anti-skid bumper 320 is fixed on a surface of the handle 32. A third through hole is defined in a rear end of the shockproof casing 3. A connector of the HDD 1 runs through the shockproof casing 3 by the third through hole. In the illustrated embodiment, the resilient material may be rubber or silicone.

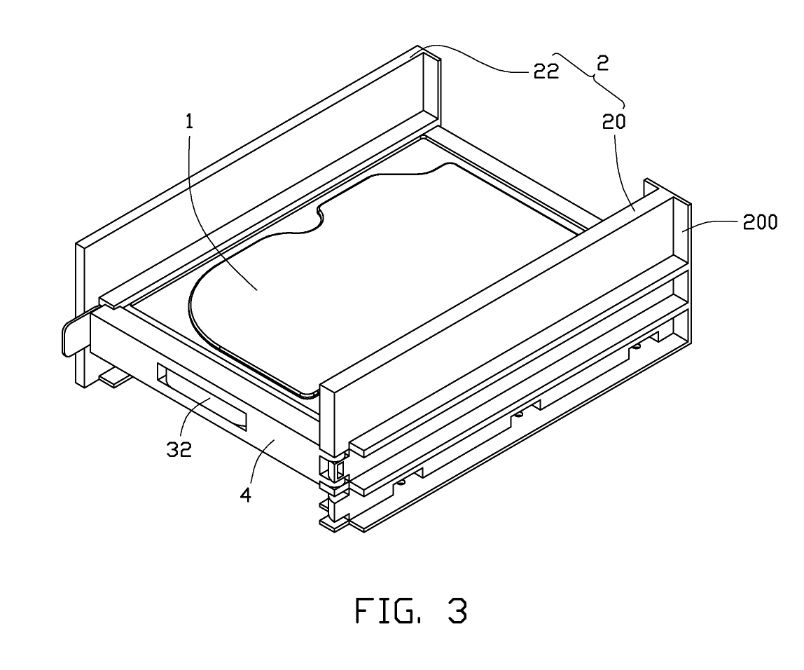

Referring to FIGS. 2 and 3, in assembly of the fixing apparatus, the shockproof casing 3 is removed, and the HDD 1 placed therein. The lock pins 30 of the shockproof casing 3 are received in the holes 12 of the HDD 1. Mounting in the shockproof casing 3 is complete. The two raised portions 40 of the gate 4 are received in the two recesses 204. The gates 4 are rotatably engaged in the first side plate 20 by a pin 6 running through the second through holes 400 of the two raised portions 40 and the first through hole of the first side plate 20. The HDD 1 in the shockproof casing 3 slides into the fixing member 2 along the rails 202 until the rear end of the shockproof casing 3 reaches the block plate 200 of the fixing member 2. The gate 4 hinges toward the second side plate 22, and then the raised blocks 422 of latching plate 42 are received in the locking slot 206 of the second side plate 22. The handle 32 of the shockproof casing 3 protrudes from the gate 4 through the cutout 44.

In removal of the HDD 1 from the fixing apparatus, the latching plate 42 is depressed toward the direction of the first side plate 20, and the raised block 422 withdraws from the locking slot 206 of the second side plate 22. The gate 4 hinges toward the first side plate 20. The shockproof casing 3 is withdrawn from the fixing member 2 by the handle 32 of the shockproof casing 3. The shockproof casing 3 is removed, and lock pins 30 of the shockproof casing 3 are withdrawn from the holes 12 of the HDD 1.

While the invention has been described by way of example and in terms of preferred embodiment, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A fixing apparatus for a hard disk drive, the fixing apparatus comprising:
a fixing member comprising a first side plate, a second side plate parallel to the first side plate, and a gate, wherein each of the first side plate and the second side plate defines a rail in corresponding inner side for receiving the hard disk drive, and wherein each of the first side plate and the second side plate comprises a block plate fixed on a rear end thereof, and wherein one end of the gate hinges on a front end of the first side plate, and the other end of the gate latches to a front end of the second side pate; and
a shockproof casing comprising a plurality of lock pins defined in each of two opposite inner sidewalls to engage with the hard disk drive, wherein the shockproof casing is made of resilient material and seats the hard disk drive.

2. The fixing apparatus of claim 1, wherein the resilient material is rubber.

3. The fixing apparatus of claim 1, wherein the resilient material is silicone.

4. The fixing apparatus of claim 1, wherein a handle is formed on a front end of the shockproof casing, and the gate defines a cutout in the center thereof through which the handle protrudes.

5. The fixing apparatus of claim 4, wherein the handle comprises an anti-skid bumper fixed on a surface of the handle.

6. The fixing apparatus of claim 1, wherein the front end of the first side plate defines two recesses, separated by a distance and positioned adjacent to the rail, and defining therebetween a fixing portion defining a first through hole.

7. The fixing apparatus of claim 1, wherein one end of the gate comprises two raised portions, separated by a distance and each defining a second through hole whereby the gate is hinged on the first side plate by a pin running through the front end of the first side plate and the second through holes of the two raised portions.

8. The fixing apparatus of claim 1, wherein the front end of the second side pate defines a locking slot, wherein the other end of the gate comprises a latching plate extending therefrom, and wherein the latching plate comprises a raised block fixed on an outer side of the latching plate.

9. The fixing apparatus of claim 8, wherein the latching plate comprises an anti-skid bumper fixed on a distal end of the latching plate.
